(19) United States
(12) Patent Application Publication
(10) Pub. No.: US 2017/0273096 A1
(43) Pub. Date: Sep. 21, 2017

(54) WIRELESS COMMUNICATION DEVICE, WIRELESS COMMUNICATION SYSTEM, AND WIRELESS COMMUNICATION METHOD

(71) Applicant: MITSUBISHI ELECTRIC CORPORATION, Tokyo (JP)

(72) Inventor: Hiroaki HIRAI, Tokyo (JP)

(73) Assignee: MITSUBISHI ELECTRIC CORPORATION, Tokyo (JP)

(21) Appl. No.: 15/505,032

(22) PCT Filed: Dec. 21, 2015
(86) PCT No.: PCT/JP2015/085659

§ 371 Date: Feb. 17, 2017

(30) Foreign Application Priority Data
Jan. 7, 2015 (JP) 2015-001864

(51) Int. Cl. H04W 72/12

(52) U.S. Cl. CPC H04W 72/12; H04W 84/20

(57) ABSTRACT

To provide a wireless communication device that can reduce the influence of periodic noises in fixed period communication using wireless communication. A wireless master device (N201) serving as a wireless master station for performing wireless communication with a wireless slave device (N301) serving as a wireless slave station includes a delay control portion (14) configured to set a delay time onto an input signal at random in every transmission period, and a wireless transmission portion (13) configured to transmit the signal to the wireless slave station (N301), while delaying the signal based on the delay time.

### FIELD

The present invention relates to a wireless communication device, a wireless communication system, and a wireless communication method, which are used for an industrial network.

### BACKGROUND

Conventionally, in an industrial network, its field network is formed by connection in a one-to-many relationship such that a controller serves as a master apparatus while various types of IO (Input Output) apparatuses and measuring apparatuses serve as slave apparatuses. Between the master apparatus and the plurality of slave apparatuses, cyclic communication is performed at preset time intervals. A technology of such a type is disclosed in Non Patent Literature 1 listed below. Further, in the case of a motion control network, in order to drive and operate a plurality of motors, timing synchronization of higher accuracy is required.

In an existing industrial network configured on the premise of fixed period communication, if an existing industrial apparatus can be used without change, by connecting a wireless apparatus externally to it, the laying cost and wiring cost can be reduced.

However, some of the industrial apparatuses used for an industrial network include a power supply, fan, motor, or the like, and it is known in general that noises are generated with a fixed period due to the power supply, fan, motor, or the like. Non Patent Literature 2 listed below discloses discussion about the influence of periodic noises given to wireless apparatuses. Under an environment including the presence of periodic noises, if the relationship between fixed period wireless communication and the period of the periodic noises is close to an integral multiple, a specific frame, such as a frame for synchronization or a frame for communication with a specific terminal, may end up continuously lacking for a certain time.

In order to suppress communication inhibition caused by periodic noises due to a motor for driving the fan of an air conditioner, Patent Literature 1 listed below discloses a technique, as follows: When road-vehicle communication or vehicle-vehicle communication is performed, a communication apparatus changes the packet transmission period at random for every time it transmits a packet. The communication apparatus generates a random number for every time it transmits one packet, and determines a packet transmission period of until transmission of the next packet, based on the value of the random number.

### CITATION LIST

### Patent Literature

Patent Literature 1: Japanese Patent Application Laid-open No. 2011-188273

### Non Patent Literature

Non Patent Literature 1: Tatsuhiko Naito; Osamu Watanabe, “Introduction to industrial Ethernet (registered trademark)”, CQ Publishing Co., Ltd., May, 2009
Non Patent Literature 2: Blankenship, T. K.; Kriztman, D. M.; Rappaport, T. S., “Measurements and simulation of radio frequency impulsive noise in hospitals and clinics”, Vehicular Technology Conference, 1997, IEEE 47th Volume: 3

### SUMMARY

### Technical Problem

However, according to the technique disclosed in Patent Literature 1 listed above, the packet to be transmitted is formed of notice information, and each of the terminals freely determines on generation of a random number and change of the transmission timing. Accordingly, if this technique is applied to adoption of wireless in fixed period communication configured on the premise of a cooperative operation, when each of the terminals randomizes the transmission timing, there are problems in that the periodicity is broken on a receiving side and the reproduction timing is thereby disordered, and/or interference is caused in a wireless zone.

The present invention has been made in view of the above, and an object of the present invention is to provide a wireless communication device that can reduce the influence of periodic noises in fixed period communication using wireless communication.

### Solution to Problem

In order to solve the problems and achieve the object, according to an aspect of the present invention, there is provided a wireless communication device serving as a wireless master station for performing wireless communication with a wireless slave station, the wireless communication device including: a delay control unit to set a delay time onto an input signal at random in every transmission period; and a wireless transmission unit to transmit the signal to the wireless slave station, while delaying the signal based on the delay time.

### Advantageous Effects of Invention

According to the present invention, there is provided an effect capable of reducing the influence of periodic noises in fixed period communication using wireless communication.

### BRIEF DESCRIPTION OF DRAWINGS

FIG. 1 is a view illustrating a configuration example of an industrial network including a wireless communication system according to a first embodiment.

FIG. 2 is a view illustrating a configuration example of a conventional industrial network.

FIG. 3 is a view illustrating a configuration example of a wireless master device and a wireless slave device according to the first embodiment.

FIG. 4 is a view illustrating timing of transmitting and receiving signals in respective devices in the industrial network including the wireless communication system according to the first embodiment.

FIG. 5 is a flow chart illustrating operations of respective devices for transmitting and receiving wireless signals in the wireless communication system according to the first embodiment.

FIG. 6 is a view illustrating timing of transmitting and receiving signals in respective devices in an industrial network including a wireless communication system according to a second embodiment.

FIG. 7 is a view illustrating timing of transmitting and receiving signals in respective devices in an industrial network including a wireless communication system according to a third embodiment.

FIG. 8 is a view illustrating timing of transmitting and receiving signals in respective devices in an industrial network including a wireless communication system according to a fourth embodiment.

FIG. 9 is a view illustrating an example of a case where a processing circuit of the wireless master device according to each of the first to fourth embodiments is constituted of dedicated hardware.

FIG. 10 is a view illustrating an example of a case where a processing circuit of the wireless master device according to each of the first to fourth embodiments is constituted of a CPU and a memory.

### DESCRIPTION OF EMBODIMENTS

Exemplary embodiments of a wireless communication device, a wireless communication system, and a wireless communication method according to the present invention will be explained below in detail with reference to the accompanying drawings. The present invention is not limited to the following embodiments.

### First Embodiment

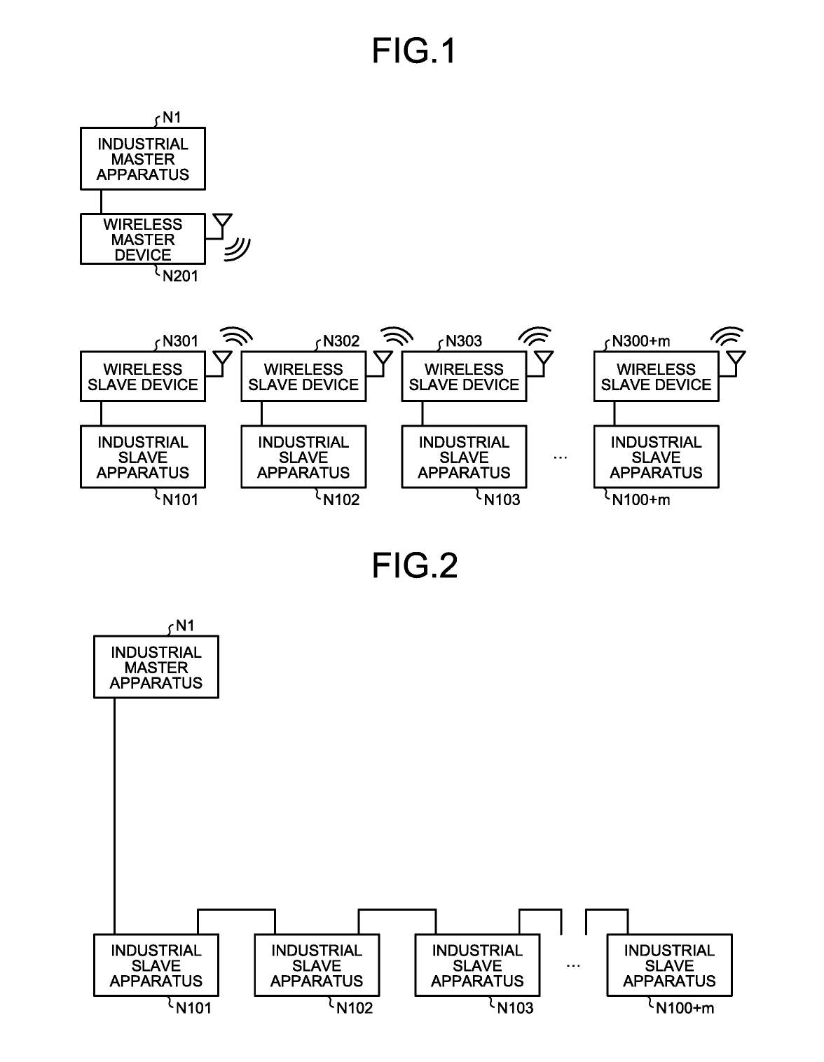

FIG. 1 is a view illustrating a configuration example of an industrial network including a wireless communication system according to a first embodiment of the present invention. The industrial network includes: an industrial master apparatus N1 serving as a controller of the industrial network; industrial slave apparatuses N101, N102, N103, - - - , and N100+m, which are various types of IO apparatuses and measuring apparatuses in the industrial network; a wireless master device N201 formed of a wireless communication device, which is connected to the industrial master apparatus N1 by a wired line, and serves as a wireless master station for performing wireless communication with the industrial slave apparatuses N101, N102, N103, - - - , and N100+m side; and wireless slave devices N301, N302, N303, - - - , and N300+m formed of wireless communication devices, which are respectively connected to the industrial slave apparatuses N101, N102, N103, - - - , and N100+m one by one by wired lines, and respectively serve as wireless slave stations for performing wireless communication with the industrial master apparatus N1 side.

The wireless communication system according to this embodiment of the present invention is composed of the wireless master device N201 and the wireless slave devices N301, N302, N303, - - - , and N300+m. In the wireless communication system, wireless communication for control communication conventionally performed with a fixed period is used between the wireless master device N201 connected to the single industrial master apparatus N1, and the wireless slave devices N301, N302, N303, - - - , and N300+m respectively connected to the m-number of industrial slave apparatuses N101, N102, N103, - - - , and N100+m.

FIG. 2 is a view illustrating a configuration example of a conventional industrial network. The industrial master apparatus N1 and the industrial slave apparatuses N101, N102, N103, and N100+m perform operations in cooperation with each other, through control communication performed with a fixed period. Here, the connection topology is formed of a daisy chain, but this is a mere example, and it may be formed of a star, bus, or ring configuration. As illustrated in FIG. 1, the topology of the wireless communication system after adoption of wireless applied according to this embodiment of the present invention is of a tree type, but this is not limiting.

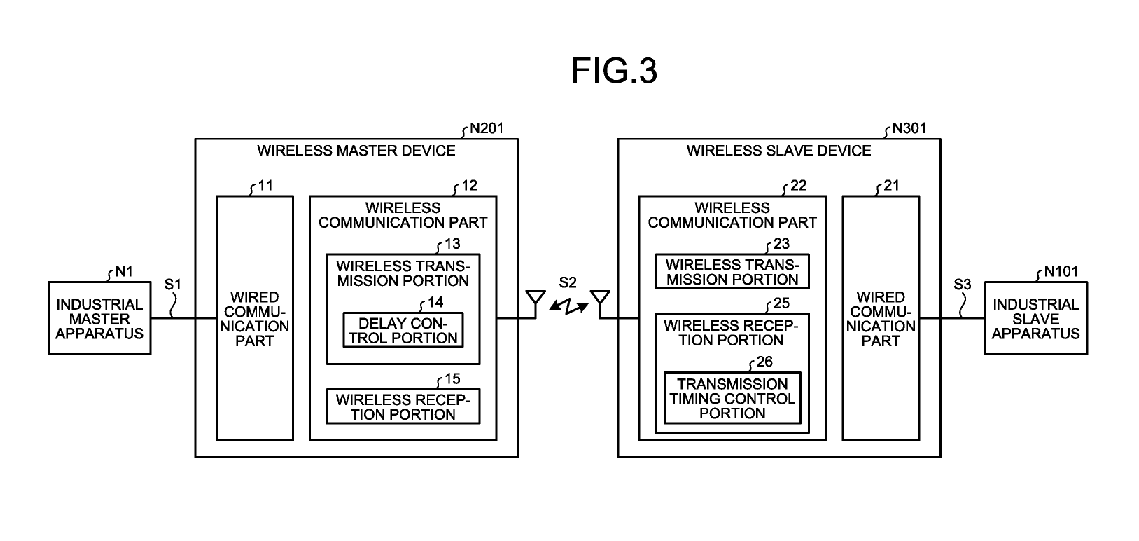

Next, an explanation will be given of the configurations of the wireless master device N201 and the wireless slave devices N301, N302, N303, - - - , and N300+m. FIG. 3 is a view illustrating a configuration example of the wireless master device N201 and the wireless slave device N301 according to the first embodiment of the present invention. Since the wireless slave devices N301, N302, N303, - - - , and N300+m have the same configuration, they will be described here by use of the wireless slave device N301.

In the industrial network, a zone connected by a wired line between the industrial master apparatus N1 and the wireless master device N201 will be referred to as a wired zone S1. Further, a zone connected by wireless between the wireless master device N201 and each of the wireless slave devices N301, N302, N303, - - - , and N300+m will be referred to as a wireless zone S2. Further, a zone connected by a wired line between each of the wireless slave devices N301, N302, N303, - - - , and N300+m and the corresponding one of the industrial slave apparatuses N101, N102, N103, - - - , and N100+m will be referred to as a wired zone S3.

The wireless master device N201 includes: a wired communication part 11 configured to transmit and receive signals of fixed period communication used in a conventional industrial network, to and from the industrial master apparatus N1 through the wired zone S1; and a wireless communication part 12 configured to transmit and receive wireless signals to and form the wireless slave devices N301 to N300+m through the wireless zone S2. The wireless communication part 12 includes: a wireless transmission portion 13 serving as a wireless transmission unit configured to change signals from the industrial master apparatus N1, which have been input through the wired communication part 11, into wireless signals, and to transmit them to the wireless slave devices N301 to N300+m via the wireless zone S2; and a wireless reception portion 15 configured to output wireless signals, which have been received from the wireless slave devices N301 to N300+m via the wireless zone S2, to the wired communication part 11. Further, the wireless transmission portion 13 includes a delay control portion 14 serving as a delay control unit configured to set a delay time onto a wireless signal at random in every transmission period and to perform control for delaying the transmission timing of the wireless signal, when the wireless signal is transmitted to each of the wireless slave devices N301 to N300+m via the wireless zone S2. Here, the delay control portion 14 may be configured independent of the wireless transmission portion 13, and disposed outside the wireless transmission portion 13.

The wireless slave device N301 includes: a wired communication part 21 serving as a communication unit configured to transmit and receive signals of fixed period communication used in a conventional industrial network, to and from the industrial slave apparatus N101 through the wired zone S3; and a wireless communication part 22 configured to transmit and receive wireless signals to and from the wireless master device N201 through the wireless zone S2. The wireless communication part 22 includes: a wireless transmission portion 23 configured to change signals from the industrial slave apparatus N101, which have been input through the wired communication part 21, into wireless signals, and to transmit them to the wireless master device N201 via the wireless zone S2; and a wireless reception portion 25 configured to output wireless signals, which have been received from the wireless master device N201 via the wireless zone S2, to the wired communication part 21. Further, the wireless reception portion 25 includes a transmission timing control portion 26 serving as a transmission timing setting unit configured to control the timing of transmitting a signal, which has been received from the wireless master device N201, to the industrial slave apparatus N101 via the wired zone S3, based on delay information obtained from a wireless signal having transmission timing delayed at random in every transmission period. Here, the transmission timing control portion 26 may be configured independent of the wireless reception portion 25, and disposed outside the wireless reception portion 25.

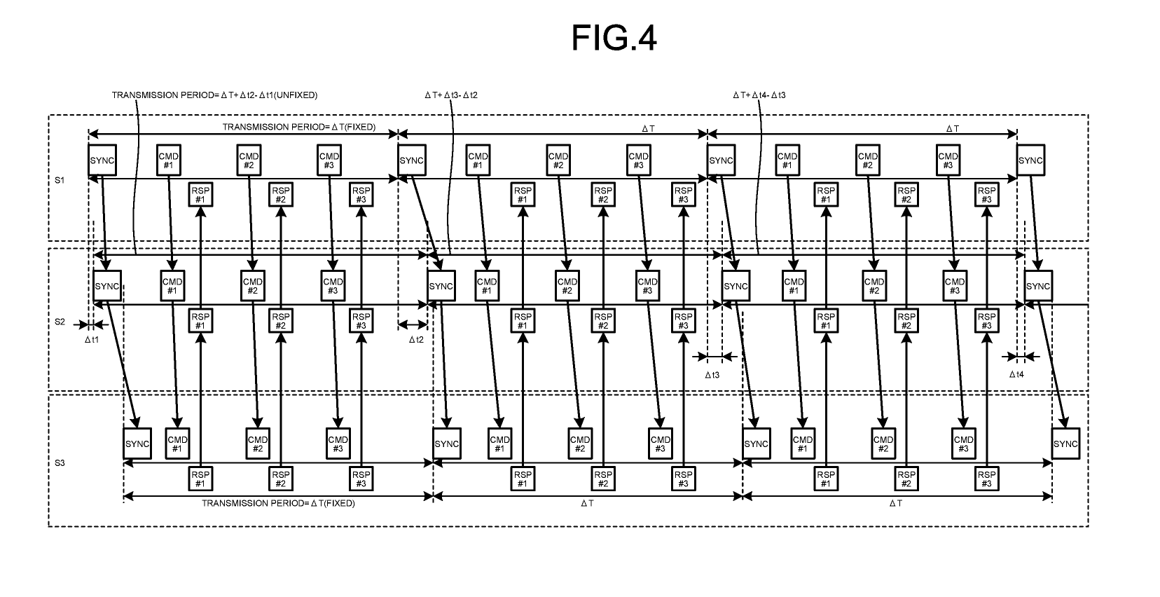

Next, an explanation will be given of operations of transmitting and receiving signals, performed by respective devices in the industrial network. FIG. 4 is a view illustrating timing of transmitting and receiving signals in respective devices in the industrial network including the wireless communication system according to the first embodiment of the present invention. Here, as an example, the explanation will be made by use of the industrial master apparatus N1, the wireless master device N201, the wireless slave devices N301 to N303, and the industrial slave apparatuses N101 to N103. However, the number of wireless slave devices and the number of industrial slave apparatuses are not limited to three, and the same effect can be obtained even if the number is one or plural. Further, the configuration of the industrial network is not limited to that illustrated in FIG. 4, and another form of an industrial network may be adopted.

In FIG. 4, SYNC indicates a control signal to be transmitted by the industrial master apparatus N1 to the industrial slave apparatuses N101 to N103 in common at the beginning of each transmission period, and so it serves as the starting point of the transmission period. The industrial slave apparatuses N101 to N103 do not transmit a response signal, even when they receive the SYNC. Further, CMD#1 indicates a control signal to be transmitted by the industrial master apparatus N1 to the industrial slave apparatus N101 in each transmission period. When the industrial slave apparatus N101 receives the CMD#1, it transmits RSP#1, which is a response signal, to the industrial master apparatus N1. Similarly, CMD#2 indicates a control signal to be transmitted by the industrial master apparatus N1 to the industrial slave apparatus N102 in each transmission period. When the industrial slave apparatus N102 receives the CMD#2, it transmits RSP#2, which is a response signal, to the industrial master apparatus N1. Similarly, CMD#3 indicates a control signal to be transmitted by the industrial master apparatus N1 to the industrial slave apparatus N103 in each transmission period. When the industrial slave apparatus N103 receives the CMD#3, it transmits RSP#3, which is a response signal, to the industrial master apparatus N1. Each of the signals SYNC, CMD#1 to CMD#3, and RSP#1 to RSP#3 is the same as a signal used in a conventional industrial network.

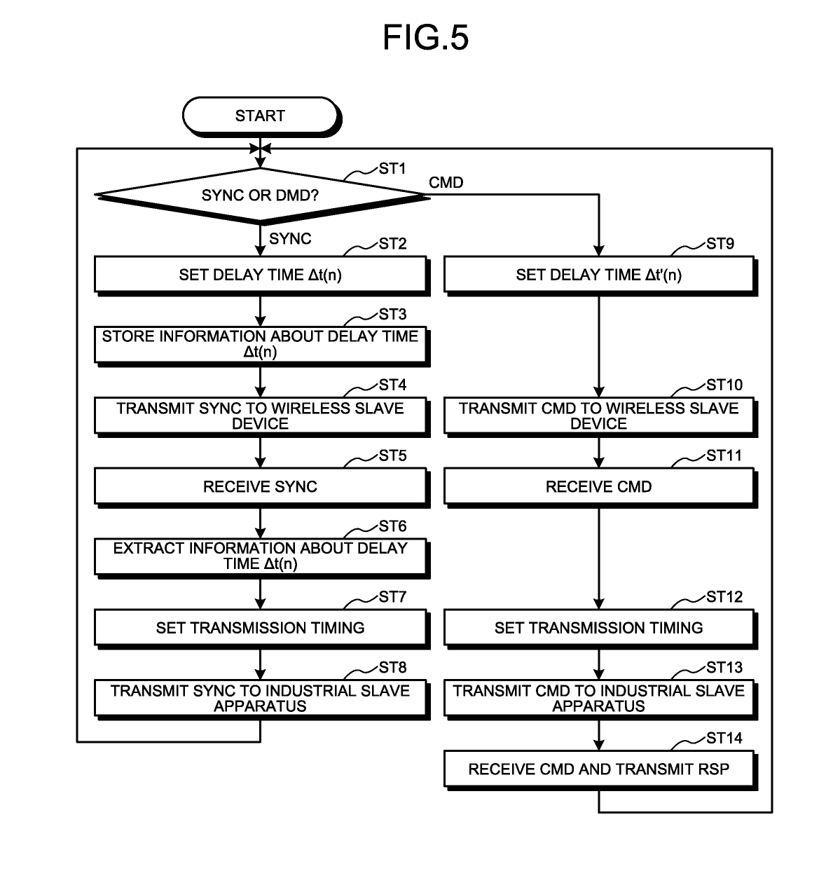

FIG. 5 is a flow chart illustrating operations of respective devices for transmitting and receiving wireless signals in the wireless communication system according to the first embodiment of the present invention.

At first, in the wireless master device N201, a transmission signal SYNC to be sent from the industrial master apparatus N1 to the industrial slave apparatuses N101 to N103 is treated, as follows: When the wired communication part 11 receives the SYNC through the wired zone S1 (step ST1: SYNC), the delay control portion 14 sets a delay time Δt(n) onto the SYNC (step ST2). The delay control portion 14 sets the delay time Δt(n) onto the SYNC to fall within a maximum delay time, which is the upper limit value of settable delay, at random in every transmission period, such that the SYNC to be transmitted to the industrial slave apparatuses N101 to N103 does not become periodic for respective transmission periods, i.e., such that the SYNC transmission intervals through the wireless zone S2 do not become regular. In the delay control portion 14, the method of setting the delay time Δt(n) at random may employ a method of using random numbers, but may employ another method.

The wireless transmission portion 13 stores, into the frame of the SYNC, information about the delay time Δt(n) set by the delay control portion 14 (step ST3), and transmits the SYNC to the wireless slave devices N301 to N303 via the wireless zone S2, while delaying the transmission timing of the SYNC by the delay time Δt(n) (step ST4). The SYNC to be transmitted from the wireless transmission portion 13 to the wireless slave devices N301 to N303 is a wireless signal.

In each of the wireless slave devices N301 to N303, when the wireless reception portion 25 receives the SYNC from the wireless master device N201 via the wireless zone S2 (step ST5), it extracts the information about the delay time Δt(n) stored in the SYNC (step ST6).

In each of the wireless slave devices N301 to N303, the transmission timing control portion 26 reproduces the delay time in the present transmission period through the wired zone S1, based on the information about the delay time Δt(n), and sets the transmission timing of transmitting the SYNC from the wired communication part 21 via the wired zone S3 to the corresponding one of the industrial slave apparatuses N101 to N103 connected to its own device (step ST7). For example, the transmission timing control portion 26 of each of the wireless slave devices N301 to N303 sets transmission timing onto the SYNC, which has been delayed by the delay time Δt(n) given by the wireless master device N201, such that the SYNC is further delayed by “the maximum delay time−the delay time Δt(n)”, i.e., such that the SYNC is delayed by the maximum delay time from the transmission time at the industrial master apparatus N1. Here, in the transmission timing control portion 26, the transmission timing may be set by use of a method other than “the maximum delay time−the delay time Δt(n)”.

The wired communication part 21 of each of the wireless slave devices N301 to N303 transmits the SYNC to the corresponding one of the industrial slave apparatuses N101 to N103 connected to its own device, via the wired zone S3, with the transmission timing set by the transmission timing control portion 26 (step ST8).

In the wireless communication system, the wireless master device N201 sets the delay time Δt(n) at random in every transmission period through the wireless zone S2, and thereby transmits the SYNC to the wireless slave devices N301 to N303 with different transmission timing depending on each transmission period. On the other hand, each of the wireless slave devices N301 to N303 sets transmission timing onto the SYNC by further use of the maximum delay time, and thereby transmits the SYNC to the corresponding one of the industrial slave apparatuses N101 to N103 always in the same time, e.g., in a state delayed by the maximum delay time as in this embodiment, relative to the starting point of the transmission period in which the industrial master apparatus N1 has transmitted the SYNC. Consequently, each of the industrial slave apparatuses N101 to N103 can receive the SYNC with the same timing in every transmission period, i.e., at regular reception intervals. The reception intervals of the SYNC at the industrial slave apparatuses N101 to N103 are the same as the SYNC transmission intervals at the industrial master apparatus N1.

Then, in the wireless master device N201, a transmission signal CMD#1 to be sent from the industrial master apparatus N1 to the industrial slave apparatus N101 is treated, as follows: When the wired communication part 11 receives the frame of the CMD#1 through the wired zone S1 (step ST1: CMD), the delay control portion 14 uses the SYNC delayed by the delay time Δt(n) as a reference, and sets a delay time Δt′(n) onto the CMD#1 based on the delay time Δt(n) (step ST9). As the delay time Δt′(n) onto the CMD#1, the delay control portion 14 may set it to be the same as the delay time Δt(n) on the SYNC, or may set it to be different from the delay time Δt(n) on the SYNC. For example, the delay control portion 14 may set the delay time Δt′(n) to be a value obtained by multiplying the delay time Δt(n) by a prescribed coefficient, but this is not limiting.

However, the delay control portion 14 can prevent complicated control, if the delay time Δt′(n) onto the CMD#1 to be sent to the industrial slave apparatus N101, a delay time Δt′(n) onto CMD#2 to be sent to the industrial slave apparatus N102 as described later, and a delay time Δt′(n) onto CMD#3 to be sent to the industrial slave apparatus N103 as described later are made in common to each other. In this embodiment, the delay control portion 14 sets the same delay time Δt′(n) onto the CDM#1 to CDM#3.

The wireless transmission portion 13 transmits the CMD#1 to the wireless slave device N301 via the wireless zone S2, while delaying the transmission timing of the CMD#1 by the delay time Δt′(n) set by the delay control portion 14 (step ST10).

In the wireless slave device N301, when the wireless reception portion 25 receives the CMD#1 from the wireless master device N201 via the wireless zone S2 (step ST11), the transmission timing control portion 26 sets the transmission timing of transmitting the CMD#1 to the industrial slave apparatus N101, based on the information about the delay time Δt(n) stored in the SYNC (step ST12), and controls the transmission timing of the CMD#1. For example, by use of the information about the delay time Δt(n), the transmission timing control portion 26 may set the transmission timing to be with a delay time the same as that of the SYNC, or may set the transmission timing to be delayed by a value obtained by multiplying the delay time Δt(n) by a prescribed coefficient, as in the delay control portion 14 of the wireless master device N201, but this is not limiting. As an example, the transmission timing control portion 26 sets the transmission timing to be delayed by use of the same method as the delay control portion 14 of the wireless master device N201.

Here, the transmission timing control portion 26 of the wireless slave device N301 sets the transmission timing of the CMD#1 based on the delay time Δt(n), and this is also true of the CMD#2 and CMD#3 described later. Specifically, the transmission timing control portion 26 of the wireless slave device N302 sets the transmission timing of the CMD#2 based on the delay time Δt(n), by use of the same method as the transmission timing control portion 26 of the wireless slave device N301. Further, the transmission timing control portion 26 of the wireless slave device N303 sets the transmission timing of the CMD#3 based on the delay time Δt(n), by use of the same method as the transmission timing control portion 26 of the wireless slave device N301.

The wired communication part 21 transmits the CMD#1 to the industrial slave apparatus N101 via the wired zone S3, with the transmission timing set by the transmission timing control portion 26 (step ST13).

When the industrial slave apparatus N101 receives the CMD#1 from the wireless slave device N301 via the wired zone S3, it transmits RSP#1, which is a response signal to the CMD#1, to the wireless slave device N301 via the wired zone S3 (step ST14).

In the wireless slave device N301, the RSP#1 to be sent from the industrial slave apparatus N101 to the industrial master apparatus N1 is treated, as follows: When the wired communication part 21 receives the RSP#1 via the wired zone S3, it outputs the RSP#1 to the wireless transmission portion 23. The wireless transmission portion 23 transmits the RSP#1 to the wireless master device N201 via the wireless zone S2.

In the wireless master device N201, when the wireless reception portion 15 receives the RSP#1 via the wireless zone S2, it outputs the RSP#1 to the wired communication part 11. The wired communication part 11 transmits the RSP#1 to the industrial master apparatus N1 via the wired zone S1.

As described above, the RSP#1 transmitted from the industrial slave apparatus N101 is not subjected to any delay control until it is received by the industrial master apparatus N1. This is also true of the RSP#2 transmitted from the industrial slave apparatus N102 and the RSP#3 transmitted from the industrial slave apparatus N103.

In the industrial network, after transmission and reception of the signals CMD#1 and RSP#1 are finished between the industrial master apparatus N1, the wireless master device N201, the wireless slave device N301, and the industrial slave apparatus N101, transmission and reception of the signals CMD#2 and RSP#2 are performed between the industrial master apparatus N1, the wireless master device N201, the wireless slave device N302, and the industrial slave apparatus N102, by use of the same method as the transmission and reception of the signals CMD#1 and RSP#1.

Further, in the industrial network, after transmission and reception of the signals CMD#2 and RSP#2 are finished between the industrial master apparatus N1, the wireless master device N201, the wireless slave device N302, and the industrial slave apparatus N102, transmission and reception of the signals CMD#3 and RSP#3 are performed between the industrial master apparatus N1, the wireless master device N201, the wireless slave device N303, and the industrial slave apparatus N103, by use of the same method as the transmission and reception of the signals CMD#1 and RSP#1.

In the industrial master apparatus N1, the wireless master device N201, the wireless slave devices N301 to N303, and the industrial slave apparatuses N101 to N103, after transmission and reception of the signals SYNC, CMD#1 to CMD#3, and RSP#1 to RSP#3 are finished in one transmission period, transmission and reception of the signals SYNC, CMD#1 to CMD#3, and RSP#1 to RSP#3 are performed in the same way also in the next transmission period.

At this time, in the wireless master device N201, the transmission signal SYNC to be sent from the industrial master apparatus N1 to the industrial slave apparatuses N101 to N103 is treated, as follows: When the wired communication part 11 receives the SYNC through the wired zone S1 (step ST1: SYNC), the delay control portion 14 sets the delay time Δt(n) onto the SYNC (step ST2). The delay control portion 14 sets the delay time Δt(n), such that the SYNC to be transmitted to the industrial slave apparatuses N101 to N103 does not become periodic for respective transmission periods, e.g., such that the delay time Δt(n) becomes different between the present transmission period and the previous transmission period, as in this embodiment.

Also in the following transmission periods, the delay control portion 14 sets a delay time Δt(n+2) to be different from a delay time Δt(n+1), and sets a delay time Δt(n+3) to be different from the delay time Δt(n+2), in the same way.

Further, in the wireless master device N201, the transmission signal CMD#1 to be sent from the industrial master apparatus N1 to the industrial slave apparatus N101 is treated, as follows: When the wired communication part 11 receives the frame of the CMD#1 through the wired zone S1 (step ST1: CMD), the delay control portion 14 uses the SYNC delayed by the delay time Δt(n) as a reference, and sets the delay time Δt′(n) onto the CMD#1 based on the delay time Δt(n) (step ST9).

Also in the following transmission periods, the delay control portion 14 sets a delay time Δt′(n+2) to be different from a delay time Δt′(n+1), and sets a delay time Δt′(n+3) to be different from the delay time Δt′(n+2), in the same way.

As illustrating in FIG. 4, the period length is inconstant and different between the transmission periods through the wireless zone S2, and so the wireless master device N201 comes to transmit the SYNC, which has been transmitted at the starting point of each transmission period, with different transmission timing depending on each transmission period. Similarly, as regards each of the CMD#1 to CMD#3 to be transmitted to the industrial slave apparatuses N101 to N103, the delay time set thereon is different in every transmission period, and so the wireless master device N201 comes to transmit it with different transmission timing depending on each transmission period.

In this way, the wireless master device N201 transmits each signal from the industrial master apparatus N1, with different timing, by setting a delay time at random in every transmission period. Consequently, even if the industrial network is under an environment including the presence of periodic noises, it is possible to reduce the influence of the periodic noises, and thereby to prevent a state where the industrial slave apparatuses N101 to N103 cannot receive a specific signal continuously for a certain time.

Further, as illustrated in FIG. 4, through the wired zone S1 between the industrial master apparatus N1 and the wireless master device N201, the industrial master apparatus N1 can transmit each of the SYNC and the CMD#1 to CMD#3 with the same timing in every transmission period, from the starting point of the transmission period. On the other hand, as regards the RSP#1 to RSP#3 in reply to the CMD#1 to CMD#3, the industrial master apparatus N1 can receive them after the lapse of the same time based on the delay time Δt(n), since transmission of the CMD#1 to CMD#3, respectively, in the same transmission period, but comes to receive each of them after the lapse of a different time depending on each transmission period.

Accordingly, the industrial master apparatus N1 is supposed to transmit the CMD#1 to CMD#3 at transmission intervals provided with some margin in consideration of the maximum delay time, to prevent interference between the RSP reception and the CMD transmission. In the industrial master apparatus N1, depending on setting of the delay time Δt(n), there may be a case where a time gap is generated between the RSP reception from a previous industrial slave apparatus and the CMD transmission to the subsequent industrial slave apparatus. However, if the CMD transmission intervals are provided with some margin, it is possible to prevent the signal interference, and to reliably realize the fixed period communication.

Further, each of the wireless slave devices N301 to N303 uses timing delayed by the maximum delay time with respect to the transmission period through the wired zone S1, as the starting point of the transmission period through the wired zone S3, and transmits the SYNC with the same timing from this starting point in every transmission period through the wired zone S3. Consequently, the industrial slave apparatuses N101 to N103 can receive the SYNC with the same timing as in the starting point of each transmission period through the wired zone S3.

In each of the wireless slave devices N301 to N303, the corresponding one of the CMD#1 to CMD#3 received from the wireless master device N201 is subjected to a different delay in every transmission period, and so timing of receiving the corresponding one of the CMD#1 to CMD#3 is different in every transmission period. Further, when the CMD#1 to CMD#3 are respectively transmitted to the industrial slave apparatuses N101 to N103, the transmission timing is also controlled. Consequently, in each of the industrial slave apparatuses N101 to N103, timing of receiving the corresponding one of the CMD#1 to CMD#3 is different in every transmission period. However, since timing of receiving the corresponding one of the CMD#1 to CMD#3 is different in every transmission period, if each of the industrial slave apparatuses N101 to N103 transmits the corresponding one of the RSP#1 to RSP#3 immediately after receiving the corresponding one of the CMD#1 to CMD#3, it can transmit the corresponding one of the RSP#1 to RSP#3 to the wireless master device N201 with different timing. The wireless slave devices N301 to N303 transmit the RSP#1 to RSP#3 to the wireless master device N201 without controlling the transmission timing.

As described above, each of the wireless slave devices N301 to N303 can transmit the signal from the corresponding one of the industrial slave apparatuses N101 to N103 with different timing, and so, even if the industrial network is under an environment including the presence of periodic noises, it is possible to reduce the influence of the periodic noises, and thereby to prevent a state where the wireless master device N201 cannot receive the signal RSP from a specific wireless slave device continuously for a certain time.

Here, the wireless slave devices N301 to N303 can receive the CMD#1 to CMD#3 within a range of the CMD transmission intervals provided with some margin by the industrial master apparatus N1.

The wireless master device N201 gives notice of the information about a set value of the delay time Δt(n) to the wireless slave devices N301 to N303 by storing the information in the SYNC, but this is not limiting. The wireless master device N201 may be configured to give notice of a seed value of the random number to the wireless slave devices N301 to N303, at the beginning of the system operation start or at regular intervals, so that a value of the delay time Δt(n) can be generated on the wireless slave devices N301 to N303 side.

As described above, according to this embodiment, a communication network includes one industrial master apparatus and one or more industrial slave apparatuses, which are configured to perform communication between them in every transmission period. A wireless communication system includes a wireless master device and one or more wireless slave devices, which are configured to perform wireless communication between them, where the wireless master device is connected to the industrial master apparatus, and the wireless slave devices are respectively connected to the industrial master apparatuses one by one, i.e., the number of the wireless slave devices being the same as that of the industrial slave apparatuses. The wireless master device sets a delay time onto a signal input from the industrial master apparatus, at random in every transmission period, and transmits the signal, which has been input from the industrial master apparatus, to the wireless slave devices, while delaying the signal based on the delay time. Each of the wireless slave devices sets the timing of transmitting the signal, which has been received from the wireless master device, to the corresponding one of the industrial slave apparatuses in the present transmission period, based on information about the delay time sent from the wireless master device, and transmits the signal with the set transmission timing. Consequently, in the industrial network serving as a communication network, and for control communication performed with a fixed period to operate the apparatuses in cooperation with each other, when communication between the industrial master apparatus and the industrial slave apparatuses is realized by use of wireless communication, there is provided the following effect: Even if the network is under an environment including the presence of periodic noises, it is possible to reduce the probability of continuously failing in communication of a specific signal or communication from a specific apparatus, and thereby to reduce the influence of the periodic noises.

It should be noted that, in this embodiment, an explanation has been given of a case where the wireless master device N201 is connected to the single industrial master apparatus N1, and the wireless slave devices N301, N302, N303, - - - , and N300+m are respectively connected to the industrial slave apparatuses N101, N102, N103, - - - , and N100+m one by one, but this is not limiting. Depending on the configuration of an industrial network, the wireless master device N201 may be connected to a plurality of industrial master apparatuses N1 that belong to different industrial networks. Further, of the wireless slave devices N301, N302, N303, - - - , and N300+m, one wireless slave device may be connected to a plurality of industrial slave apparatuses.

### Second Embodiment

In the first embodiment, the delay control portion 14 of the wireless master device N201 and the transmission timing control portion 26 of the wireless slave devices N301 to N303 are configured to perform control for delaying the transmission timing of the CMD#1 to CMD#3, but the control method of the transmission timing is not limited to this.

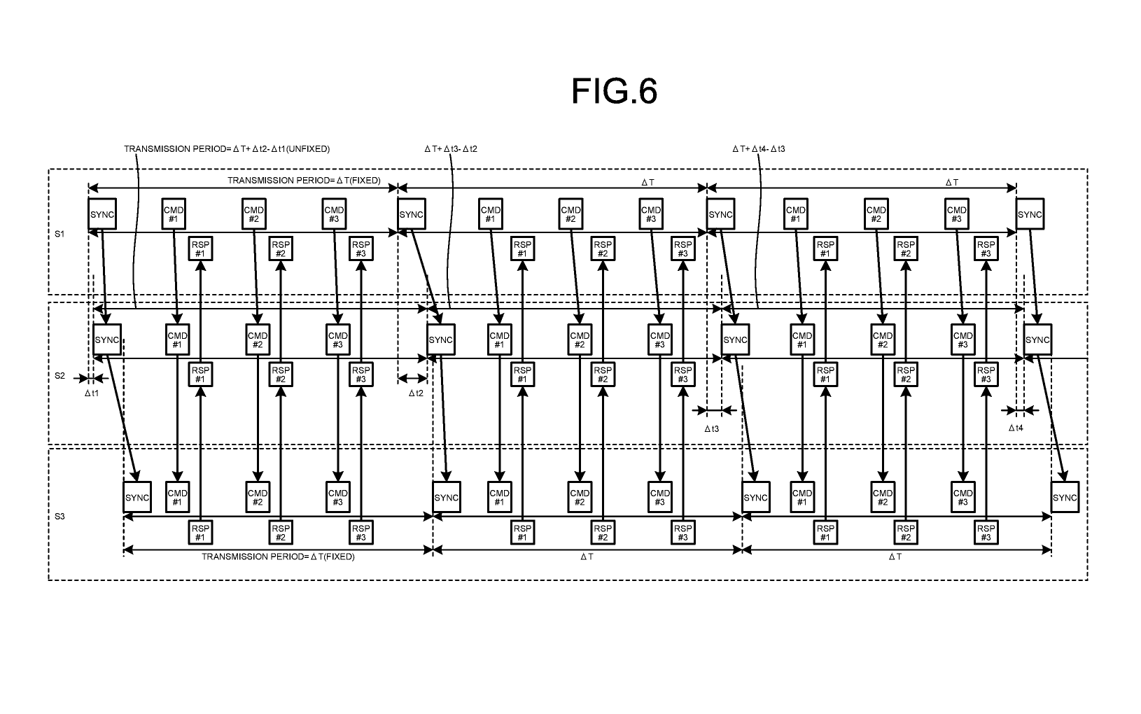

FIG. 6 is a view illustrating timing of transmitting and receiving signals in respective devices in an industrial network including a wireless communication system according to a second embodiment of the present invention. The configuration of the wireless communication system is the same as that of the first embodiment. In the wireless slave devices N301 to N303, if there is no interference between the timing of transmitting the SYNC to the industrial slave apparatuses N101 to N103 and the timing of transmitting the CMD#1 to CMD#3 to the industrial slave apparatuses N101 to N103, the wireless slave devices N301 to N303 may be configured to transmit the CMD#1 to CMD#3 to the industrial slave apparatuses N101 to N103 without controlling their transmission timing, i.e., without giving a delay to them. Here, the wireless slave devices N301 to N303 control the transmission timing of the SYNC in the same way as the first embodiment.

Accordingly, the transmission timing control portion 26 of the wireless slave devices N301 to N303 sets transmission timing that gives no delay onto the CMD#1 to CMD#3, in the step ST12 of the flow chart illustrated in FIG. 5, and thus the computing load can be reduced.

### Third Embodiment

In the first embodiment, the delay control portion 14 of the wireless master device N201 and the transmission timing control portion 26 of the wireless slave devices N301 to N303 are configured to perform control for delaying the transmission timing of the CMD#1 to CMD#3, but the control method of the transmission timing is not limited to this. Next, an explanation will be give of a method different from that of the second embodiment.

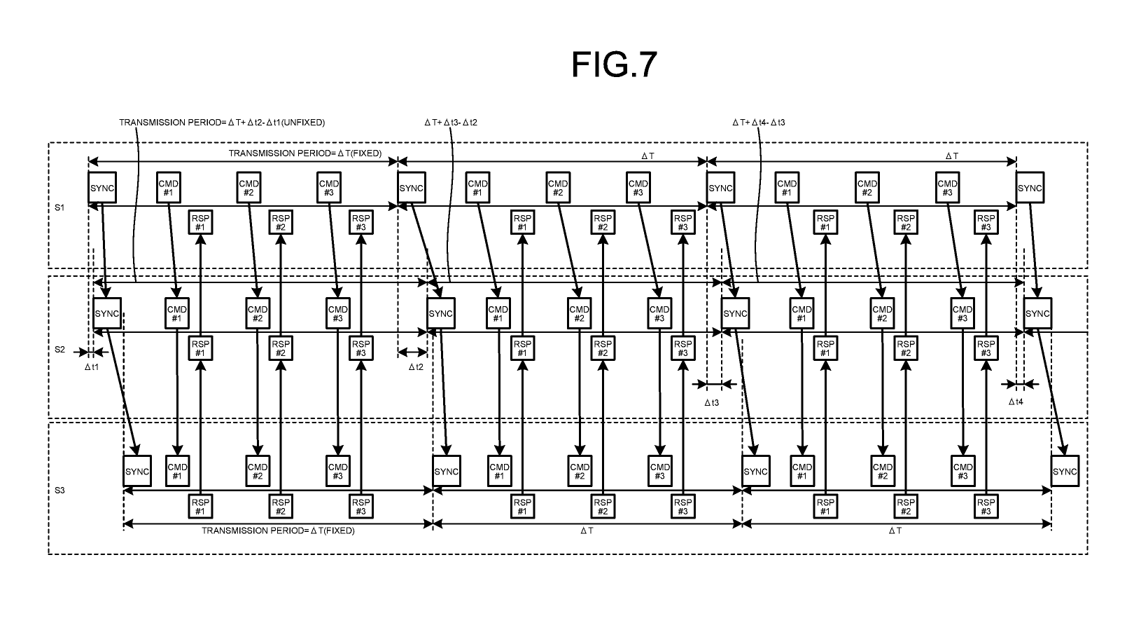

FIG. 7 is a view illustrating timing of transmitting and receiving signals in respective devices in an industrial network including a wireless communication system according to a third embodiment of the present invention. The configuration of the wireless communication system is the same as that of the first embodiment. The delay control portion 14 of the wireless master device N201 may be configured to provide, by itself, the CMD#1 to CMD#3 with a delay time obtained by summing the delay time given to the CMD#1 to CMD#3 by the wireless master device N201 illustrated in FIG. 4 and the delay time given to the CMD#1 to CMD#3 by each of the wireless slave devices N301 to N303 illustrated in FIG. 4. Here, the wireless slave devices N301 to N303 control the transmission timing of the SYNC in the same way as the first embodiment.

As in the second embodiment, the transmission timing control portion 26 of the wireless slave devices N301 to N303 sets transmission timing that gives no delay onto the CMD#1 to CMD#3, in the step ST12 of the flow chart illustrated in FIG. 5, and thereby reduces the computing load.

### Fourth Embodiment

In the first embodiment, the transmission timing control portion 26 of the wireless slave devices N301 to N303 is configured to set transmission timing that givens a delay corresponding to a value obtained by multiplying the delay time Δt(n) by a prescribed coefficient, based on the delay time Δt(n) sent from the wireless master device N201, as in the delay control portion 14 of the wireless master device N201, but this is not limiting.

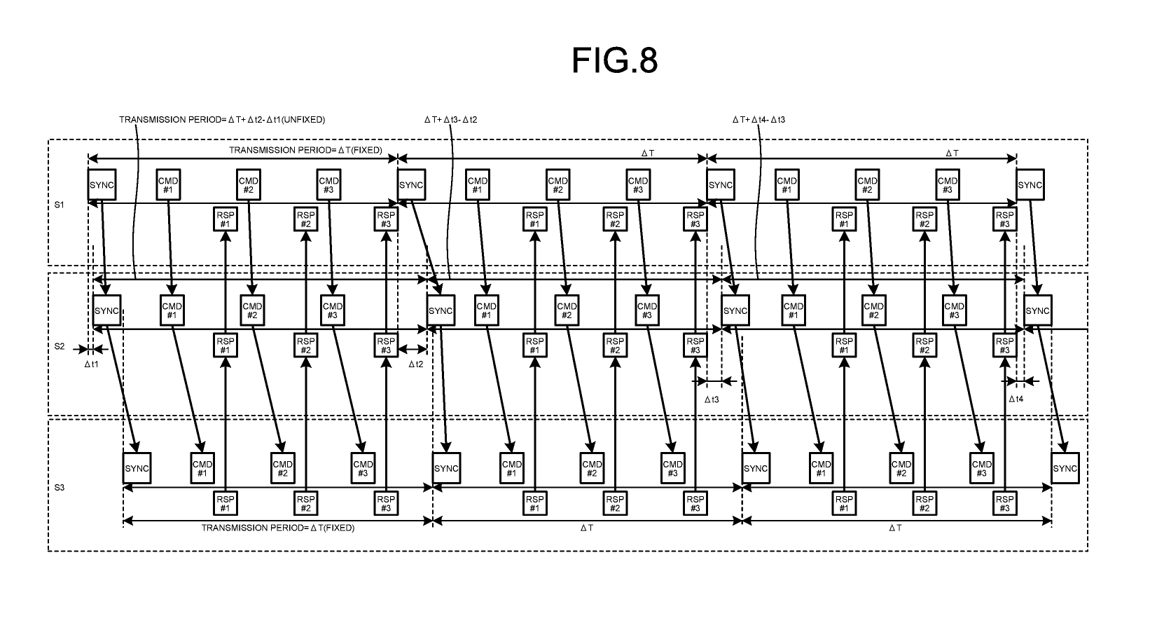

FIG. 8 is a view illustrating timing of transmitting and receiving signals in respective devices in an industrial network including a wireless communication system according to a fourth embodiment of the present invention. The configuration of the wireless communication system is the same as that of the first embodiment. For example, the transmission timing control portion 26 sets transmission timing onto the CMD, which has been delayed by the delay time Δt′(n) given by the wireless master device N201, such that the CMD is further delayed by “the CMD transmission interval set by the wireless master device N201−the delay time Δt′(n)”. Each of the wireless slave devices N301 to N303 can reproduce the fixed period communication performed in the wireless master device N201, and can transmit the corresponding one of the CMD#1 to CMD#3 to the corresponding one of the industrial slave apparatuses N101 to N103, always with the same timing in every transmission period, in spite of the delay time Δt(n) set by the wireless master device N201. Here, the wireless slave devices N301 to N303 control the transmission timing of the SYNC in the same way as the first embodiment.

In this case, it is possible to utilize an industrial master apparatus N1 and industrial slave apparatuses N101 to N103 of an existing industrial network that requires synchronization timing reproduced from fixed period communication, without changing them. However, each of the industrial slave apparatuses N101 to N103 comes to transmit the corresponding one of the RSP#1 to RSP#3 to the industrial master apparatus N1, always with the same timing in every transmission period, and so it cannot transmit the corresponding one of the RSP#1 to RSP#3 with different timing in every transmission period.

The wireless communication system according to the present invention is useful in a case where an industrial network system is realized by including a wireless master device configured to delay the transmission period of each signal through a wireless zone at random, and a wireless slave device configured to control the transmission timing of each signal delayed at random, which are connected to each other by wireless.

Next, an explanation will be given of the hardware configuration of the wireless master device N201. In the wireless master device N201, the wired communication part 11 is realized by a wired communication interface circuit. In the wireless communication part 12, each of a wireless transmission portion 13 including no delay control portion 14 or the part other than the delay control portion 14 in the wireless transmission portion 13 including the delay control portion 14, and the wireless reception portion 15 is realized by a wired communication interface circuit. The delay control portion 14 is realized by a processing circuit. Specifically, the wireless master device N201 includes a processing circuit for setting a delay time onto an input signal at random in every transmission period. The processing circuit may be formed of dedicated hardware, or may be formed of a CPU (Central Processing Unit) and a memory, where the CPU is configured to execute a program stored in the memory.

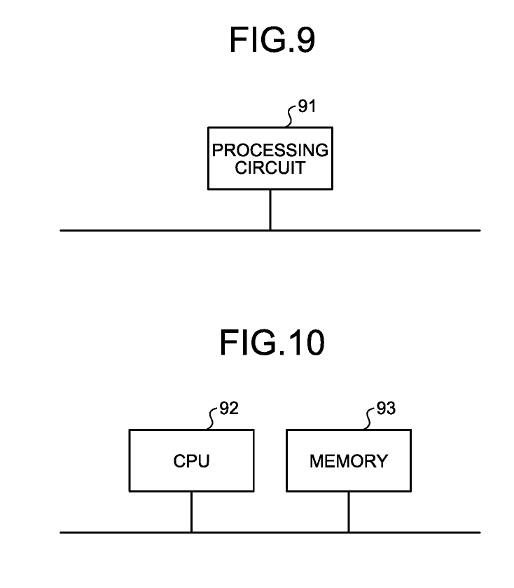

FIG. 9 is a view illustrating an example of a case where the processing circuit of the wireless master device N201 according to each of the first to fourth embodiments is constituted of dedicated hardware. In a case where the processing circuit is constituted of dedicated hardware, for example, the processing circuit 91 illustrated in FIG. 9 corresponds to a single circuit, combined circuit, programmed processor, parallel-programmed processor, ASIC (Application Specific Integrated Circuit), FPGA (Field Programmable Gate Array), or combination thereof. The functions of the delay control portion 14 may be respectively realized by processing circuits 91, or the functions may be realized by a processing circuit 91 as a whole.

FIG. 10 is a view illustrating an example of a case where the processing circuit of the wireless master device N201 according to each of the first to fourth embodiments is constituted of a CPU and a memory. In a case where the processing circuit is constituted of a CPU 92 and a memory 93, the functions of the delay control portion 14 are realized by software, firmware, or combination of software and firmware. The software or firmware is described as a program, and stored in the memory 93. In the processing circuit, the CPU 92 reads and executes the program stored in the memory 93, and thereby realizes the functions of respective parts. Specifically, the wireless master device N201 is equipped with the memory 93 that stores a program for performing a step of setting a delay time onto an input signal at random in every transmission period, as a result of execution by the processing circuit. In other words, programs of this kind are supposed to cause a computer to conduct sequences and methods in the delay control portion 14. Here, the CPU 92 may be formed of a processing device, computing device, micro processor, micro computer, processor, or DSP (Digital Signal Processor). Further, for example, the memory 93 corresponds to a nonvolatile or volatile semiconductor memory, such as a RAM (Random Access Memory), ROM (Read Only Memory), flash memory, EPROM (Erasable Programmable ROM), or EEPROM (Electrically EPROM); magnetic disk; flexible disk; optical disk; compact disk; mini disk; or DVD (Digital Versatile Disc).

Here, the respective functions of the delay control portion 14 may be partly realized by dedicated hardware and partly realized by software or firmware.

In this way, the processing circuit can realize the respective functions described above by use of dedicated hardware, software, firmware, or combination thereof.

The hardware configuration has been described about the wireless master device N201, but the same configuration can be also applied to description about the wireless slave devices N301 to N300+m. In the wireless slave devices N301 to N300+m, the wired communication part 21 is realized by a wired communication interface circuit. In the wireless communication part 22, each of a wireless reception portion 25 including no transmission timing control portion 26 or the part other than the transmission timing control portion 26 in the wireless reception portion 25 including the transmission timing control portion 26, and the wireless transmission portion 23 is realized by a wired communication interface circuit. The transmission timing control portion 26 is realized by a processing circuit, as in the delay control portion 14 of the wireless master device N201.

The configurations illustrated in the above embodiments are mere examples of the contents of the present invention, and they may be combined with other known techniques. Further, the configurations may be partly omitted or changed without departing from the spirit of the present invention.

### REFERENCE SIGNS LIST

11, 21 wired communication part, 12, 22 wireless communication part, 13, 23 wireless transmission portion, 14 delay control portion, 15, 25 wireless reception portion, 26 transmission timing control portion, N1 industrial master apparatus, N101, N102, N103, - - - , N100+m industrial slave apparatus, N201 wireless master device, N301, N302, N303, - - - , N300+m wireless slave device.

1-10. (canceled)

11. A wireless communication device serving as a wireless master station for performing wireless communication with a wireless slave station,
the wireless communication device comprising:
a delay control unit to set a delay time onto an input signal at random in every transmission period; and
a wireless transmission unit to transmit the signal to the wireless slave station, while delaying the signal based on the delay time,
wherein the wireless transmission unit is configured to store information about the delay time into one signal of the input signals, the one signal serving as a starting point of the transmission period, so as to transmit the information to the wireless slave station.

12. A wireless communication device serving as a wireless master station for performing wireless communication with a wireless slave station,
the wireless communication device comprising:
a delay control unit to set a delay time onto an input signal at random in every transmission period; and
a wireless transmission unit to transmit the signal to the wireless slave station, while delaying the signal based on the delay time,
wherein the delay control unit is configured to set a same delay time in a same transmission period onto respective signals of the input signals, for which a response is to be sent back in reply to transmission.

13. The wireless communication device according to claim 11, wherein the wireless communication device is connected to a master apparatus to perform communication in every transmission period with a slave apparatus connected to the wireless slave station,
wherein the input signal of the delay control unit is input from the master apparatus.

14. A wireless communication device serving as a wireless slave station for performing wireless communication with a wireless master station, wherein the wireless master station is configured to set a delay time onto an input signal at random in every transmission period, and to transmit the signal to the wireless slave station, while delaying the signal based on the delay time,
the wireless communication device comprising:
a transmission timing setting unit to set transmission timing onto the signal in a present transmission period, based on information about the delay time sent from the wireless master station; and
a communication unit to transmit the signal, which has been received from the wireless master station, with the transmission timing.

15. The wireless communication device according to claim 14, wherein the transmission timing setting unit is configured to set transmission timing to delay transmission, based on the delay time, onto a signal received from the wireless master station, for which a response is to be sent back in reply to transmission.

16. The wireless communication device according to claim 14, wherein the transmission timing setting unit is configured to set transmission timing not to delay transmission onto a signal received from the wireless master station, for which a response is to be sent back in reply to transmission.

17. The wireless communication device according to claim 14, wherein the wireless communication device is connected to a slave apparatus to perform communication in every transmission period with a master apparatus connected to the wireless master station,
wherein the communication unit is configured to transmit the signal, which has been received from the wireless master station, to the slave apparatus with the transmission timing.
